(19) United States
(12) Patent Application Publication
(10) Pub. No.: US 2005/0089728 A1
(43) Pub. Date: Apr. 28, 2005

(54) Electrochemical energy storage device

(76) Inventors: Juichi Arai, Katsura (JP); Yoshiaki Kumashiro, Mito (JP); Mituru Kobayasi, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/785,992

(22) Filed: Feb. 26, 2004

(30) Foreign Application Priority Data
Oct. 27, 2003 (JP) 2003-365961

(51) Int. Cl. H01M 14/00; H01M 4/66

(52) U.S. Cl. 429/7; 429/209; 429/245; 429/234

(57) ABSTRACT

To acquire a high-output electrochemical energy storage device the range of operating voltage of which is large, a positive electrode provided with a positive electrode collector and positive electrode active material which is held by the positive electrode collector and can occlude/emit a metal ion, a negative electrode provided with a negative electrode collector and negative electrode active material which is held by the negative electrode collector and can occlude/emit the metal ion, a minutely porous separator held between the positive electrode and the negative electrode and an organic electrolyte are provided, and a range of operating voltage is equivalent to a range from below 2 V to 4 V or more.

### FIELD OF THE INVENTION

The present invention relates to an electrochemical energy storage device that repeatedly stores electrochemical energy and can repeatedly utilize the electrochemical energy.

### BACKGROUND OF THE INVENTION

Heretofore, for a device that stores electrochemical energy, a lead battery using an aqueous electrolyte, a nickel-cadmium battery, a nickel-hydrogen battery or a lithium secondary battery using a non-aqueous electrolyte is widely used in social life.

The voltage range of these batteries is 2 V or less and is small, and in case large voltage is required as in an electric vehicle and a power tool, the number of serially connected batteries increases and the situation is disadvantageous. Concretely, as to the battery using an aqueous electrolyte, the voltage range is 1.5 to 2 V and as to the lithium secondary battery, though the operating voltage is high (2.5 to 4.2 V), the voltage range is also approximately 1.7 V.

In case the lithium secondary battery is utilized for an electric vehicle and a power tool, an output characteristic is required to be enhanced. For one of methods, a device that capacitance generated by electrochemical ion absorption is applied to an electrode can be designated. For example, in JP-A 260634/2002 (Abstract, Paragraphs 0056, 0061), a method of mixing activated carbon which can express a characteristic of a capacitor in a positive electrode is disclosed.

Besides, a lithium secondary battery including activated carbon in a negative electrode is described as a comparative example, however, in this case, no activated carbon is added to the positive electrode. It is described that in such a secondary battery, both constant service capacity and constant-current constant-voltage discharge current capacity are deteriorated, compared with a secondary battery including no activated carbon in the negative electrode. In the patent document 1, it is not described that carbonaceous material such as activated carbon is added to both the positive electrode and the negative electrode. Besides, in JP-A 260634/2002, as aluminum is used for a collector, the final voltage of discharge is regulated to approximately 2 V maximum (Abstract, Paragraphs 0056, 0061).

### SUMMARY OF THE INVENTION

The object of the invention is to provide a new electrochemical energy storage device also effective in powerful use the voltage of which is high and in which a range of operating voltage is large.

The invention provides the new electrochemical energy storage device and solves the above-mentioned problems. That is, the invention provides an electrochemical energy storage device provided with a positive electrode having a positive electrode collector and positive electrode active material which is held by the positive electrode collector and can electrochemical adsorp/desorp a metal ion, a negative electrode having a negative electrode collector and negative electrode active material which is held by the negative electrode collector and can electrochemical adsorp/desorp the metal ion, a minutely porous separator held between the positive electrode and the negative electrode and an organic electrolyte and characterized in that a range of the operating voltage is equivalent to a range from below 2 V to 4 V or more.

In a desirable embodiment of the invention, for a positive electrode collector, undissolved material even in an electrolyte in charge/discharge, for example, carbonaceous material is used or the surface of a metallic base substance is coated with carbonaceous material so that the metallic base substance is not dissolved even in an electrolyte in charge/discharge. Hereby, a range of the operating voltage of an energy storage device can be extended up to a far larger region (a range from below 2 V to 4 V or more, particularly a range from 0 V to 4.2 V) than a range of a conventional type lithium battery.

According to example 1 of the invention, an electrochemical energy storage device provided with a positive electrode having a positive electrode collector made of carbonaceous material and positive electrode active material which is held by the positive electrode collector and can occlude/emit a metal ion, a negative electrode having a negative electrode collector made of carbonaceous material and negative electrode active material which is held by the negative electrode collector and can occlude/emit the metal ion, a minutely porous separator inserted between the positive electrode and the negative electrode and an organic electrolyte can be provided.

These inventors considered setting the final voltage of discharge up to 0 V to acquire high output to be capable and further, considered raising voltage utilizing the capacitance of an electric double layer capacitor. To achieve these, the inventors used carbonaceous material such as a carbon fiber and activated carbon to which capacitance could be applied for the positive electrode collector and the negative electrode collector. The carbonaceous material having a capacitance characteristic such as a carbon fiber and activated carbon functions as a part of electrode material and also functions as a collector. The carbon fiber itself may be also activated carbon.

In the conventional type lithium secondary battery, it is general that aluminum foil is used for a positive electrode collector and copper foil is used for a negative electrode collector, however, when voltage is in the vicinity of 0 V because of over discharge, the elution of copper starts and battery capacitance is remarkably deteriorated. Therefore, an over discharge control circuit for preventing discharge voltage from being 2.5 V or less is required. In the invention, as a collector dissolved in the case of over discharge is not essentially used, a collector can be used even if discharge voltage is 2.5 V or less and substantial battery capacitance can be enhanced. Besides, there is also effect that the quantity of the capacitance of the carbonaceous material is added to battery capacitance.

It is desirable that either of the positive electrode collector or the negative electrode collection or both carbonaceous materials is/are a carbon fiber convenient for maintaining the contour of a base substance. Further, it is preferable that either of the positive electrode or the negative electrode or both carbon fibers is/are woven cloth.

In the invention, either of the positive electrode (the collector including carbonaceous material and active material) or the negative electrode (the collector including carbonaceous material and active material) or both may be also held on a plastic sheet. Besides, either of the positive electrode or the negative electrode or both collector base substances may be also held on a metallized plastic sheet.

In the invention, it is desirable to mix positive electrode active material or negative electrode active material with either of the carbonaceous positive electrode collector or the carbonaceous negative electrode collector or both or to apply active material to either or both. Besides, either of the positive electrode collector or the negative electrode collector or both is/are a collector base substance and in this case, another base material may be also omitted.

Further, the positive electrode active material and the negative electrode active material of either of the positive electrode or the negative electrode or of both may be also applied to a carbonaceous base substance of the positive electrode and a carbonaceous base substance of the negative electrode. It is desirable that the carbonaceous material of either of the positive electrode or the negative electrode or of both electrochemically absorbs or emits the metal ion.

If the new electrochemical energy storage device according to the invention is used, the large-capacity, high-energy density, high-voltage and high-operating voltage device can be acquired, and a power supply module including much series can be more miniaturized and lightened.

### BRIEF DESCRIPTION OF THE DRAWINGS

FIG. 1 is a schematic drawing for explaining a concept of an electrochemical energy device according to the invention;

FIGS. 2A and 2B are graphs for explaining each action of the electrochemical energy device according to the invention and a conventional type battery;

FIG. 3 is a cross sectional view showing the structure of a device for testing and evaluation equivalent to one embodiment of the invention; and

FIG. 4 is a graph showing the result of an operating characteristic test of an electrochemical energy storage device equivalent to example 1 of the invention.

### DETAILED DESCRIPTION OF THE PREFERRED EMBODIMENTS

Embodiments of the invention will be described below. Needless to say, the invention is not limited to the following.

A collector including either of the above-mentioned positive electrode or the above-mentioned negative electrode or both carbonaceous materials electrochemically absorbs or emits the above-mentioned metal ion. Further, it is desirable that activated carbon is held in the above-mentioned carbonaceous collector. It is desirable that the mean diameter of used activated carbon is 5 to 150 μm.

For a substance which occludes/emits a metal ion in the positive electrode, lithium metallic oxide, a phosphatic compound including lithium, a metallic complex including lithium, the transition metal composite oxide of alkali metal and the transition metal composite oxide of alkaline earth metal can be given.

For a substance which occludes/emits a metal ion in the negative electrode, alkali metal such as lithium, alkaline earth metal, silicon, silicon oxide, tin, tin oxide, germanium, germanium oxide, aluminum, aluminum oxide, zinc, zinc oxide or the mixture of these and carbonaceous material (including graphite) or carbonaceous material (including graphite) can be given. Active material enters carbonaceous material, particularly the inside of carbon fiber by mixing any of these positive electrode active materials or any of these negative electrode active materials with carbonaceous material or by applying any of the above-mentioned active materials to carbonaceous material as a base substance.

For an electrolyte, an organic electrolyte using an organic solvent acquired by dissolving a lithium salt, a gel electrolyte acquired by mixing a macromolecule to this or a solid electrolyte acquired by dissolving a lithium salt in a high molecular matrix can be used. Further, for an electrolyte, organic solution acquired by dissolving an alkaline metallic salt or a salt of alkaline earth metal, a gel electrolyte or a solid electrolyte can be utilized.

As lithium has the basest oxidation-reduction potential out of all elements, a device the voltage of which is the highest can be acquired if an organic electrolyte acquired by dissolving a lithium salt, a positive electrode and a negative electrode which can use lithium for a mobile ion are used.

Besides, in case an electrolyte using a salt of alkaline earth metal is utilized, current density in charge/discharge can be enhanced as the number of mobile ions is large. For an electrode, a collector base substance including material selected in a group composed of lithium metallic oxide, a phosphatic compound including lithium, a metallic complex including lithium, the transition metal composite oxide of alkali metal and the transition metal composite oxide of alkaline earth metal and including carbonaceous material is used for a positive electrode.

The above-mentioned positive electrode active material or the above-mentioned negative electrode active material is held and used for a collector base substance provided with carbonaceous material. For a method of holding, there is a method of applying the above-mentioned active material to the mixture of the above-mentioned carbonaceous material and the above-mentioned active material or carbonaceous material. In case a collector base substance made of carbonaceous material is woven cloth, a positive electrode and a negative electrode infiltrate into a void of carbonaceous fiber, can be formed and the case is advantageous in energy density and output density.

For a separator inserted between the positive electrode and the negative electrode for passing a metal ion and preventing the short circuit of both electrodes, a minutely porous film of thermoplastic resin such as polypropylene is used. As well-known, when the temperature of a battery abnormally rises and many minute pores are closed so that battery reaction is halted and safety is secured.

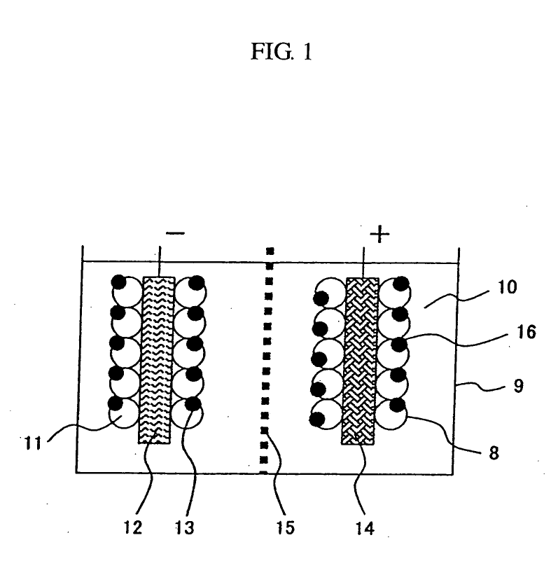

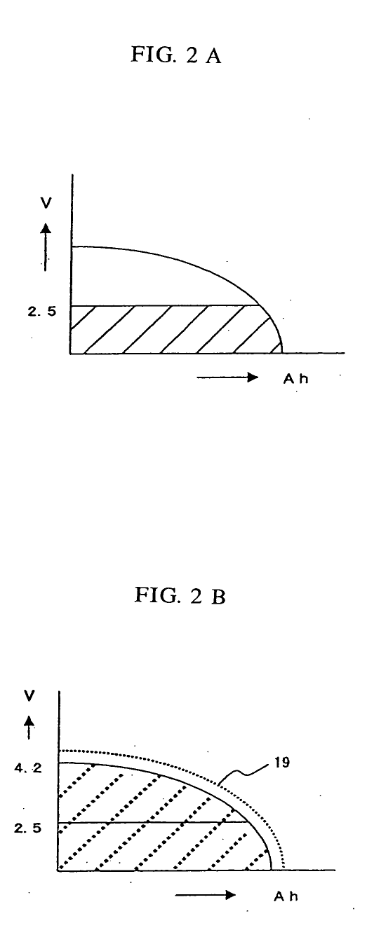

Referring to FIGS. 1 and 2, an outline of an electrochemical energy device according to the invention will be described below. As shown in FIG. 1, a device case 9 includes a positive electrode 18 and a negative electrode 17, a separator 15 arranged between the positive electrode and the negative electrode and an electrolyte 10. The positive electrode 18 makes a carbonaceous base substance 14 hold a positive electrode substance 8 and activated carbon 16 if necessary. The carbonaceous base substance 14 and the activated carbon 16 absorb a negative ion such as BF₄⁻ and PF₆⁻ and form an electric double layer capacitor. The negative electrode 17 makes a carbonaceous base substance 12 hold a negative electrode substance 11 and activated carbon 13. The carbonaceous collector and the activated carbon also form an electric double layer capacitor like the positive electrode. In case the carbonaceous base substances 12, 14 are made of activated carbon (for example, when activated carbon fiber is used), the activated carbons 8, 13 are not required to be used.

As described above, in a conventional type lithium secondary battery using metal such as copper for a negative electrode collector, as elution occurs when charge/discharge voltage is 2.5 V or less, the terminating voltage of discharge is set to 2.5 V or more by an over discharge control circuit as shown in FIG. 2A. Therefore, for usable service capacity, a hatched area shown in FIG. 2A is not utilized and only an area over the area is utilized.

In the invention, as the positive electrode collector and the negative electrode collector are made of carbonaceous material, elution is not caused in the collectors in over discharge and the termination of discharge voltage is not required to be set to 2.5 V. Therefore, in the invention, service capacity in a range hatched by a dotted line shown in FIG. 2B is acquired. Further, in the invention, as a function of a capacitor is added, discharge voltage is further enhanced as shown by a dotted curve 19 in FIG. 2B and there is effect that service capacity is enhanced by the quantity.

### EXAMPLES

The invention will be described based upon embodiments further in detail below. The invention is not limited to the following examples.

### Example 1

For positive electrode active material, a coprecipitated body of oxide composed of Mn, Ni, Co and Li₂CO₃ are mixed, next, are burned at 1050° C. under atmospheric air and LiMn_{0.4}Ni_{0.4}Co_{0.2}O₂ is acquired. These are mixed with N-methyl pyrolidone which is a solvent using polyvinylidene fluoride (hereinafter called PVDF) as a binder and positive electrode material paste is produced. For a collector base substrate provided with carbonaceous material, a positive electrode 2 related to an electrochemical energy storage device according to the invention is produced by applying the produced positive electrode material paste to woven cloth 280 μm thick made of a carbonaceous fiber of activated carbon, heating and pressurizing it.

As positive electrode material can infiltrate into a void inside the collector base substance when woven cloth made of a carbonaceous fiber is used as described above, the effectively usable capacity of the electrode can be increased and the energy density of the device can be further enhanced.

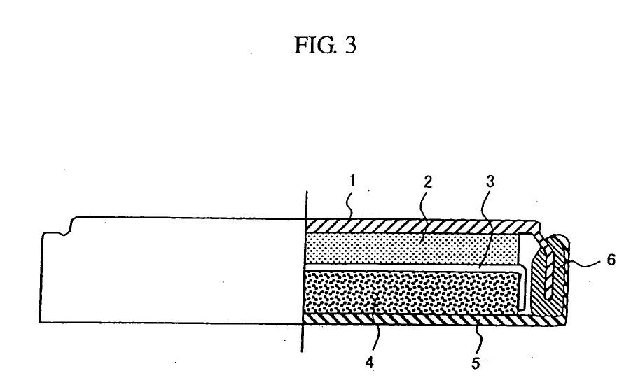

Next, negative electrode material paste is produced by using artificial graphite carbon for negative electrode material, using PVDF for a binder and mixing these with N-methyl pyrolidone which is a solvent. A negative electrode 4 related to the electrochemical energy storage device according to the invention is produced by applying the produced negative electrode material paste to woven cloth (ACC-561 manufactured by Japan Kainol) made of a carbonaceous fiber as a collector base substance provided with carbonaceous material, heating and pressurizing it. These electrodes are punched in the diameter of 15 mm. A minutely porous separator 3 made of polyethylene and processed in the diameter of 17 mm is held between the electrodes. For an electrolyte, to be the concentration of 1 mol/dm³, LiPF₆ is added to a mixed solvent acquired by mixing ethylene carbonate (hereinafter called EC) and dimethyl carbonate (hereinafter called DMC) at the capacity ratio of 1:2 (EC:DMC), and a device for testing having structure shown in FIG. 3 is produced. As shown in FIG. 3, the positive electrode 2, the separator 3 and the negative electrode 4 are arranged between a positive electrode cap 1 and a negative electrode can 5 and the battery is sealed by a gasket 6.

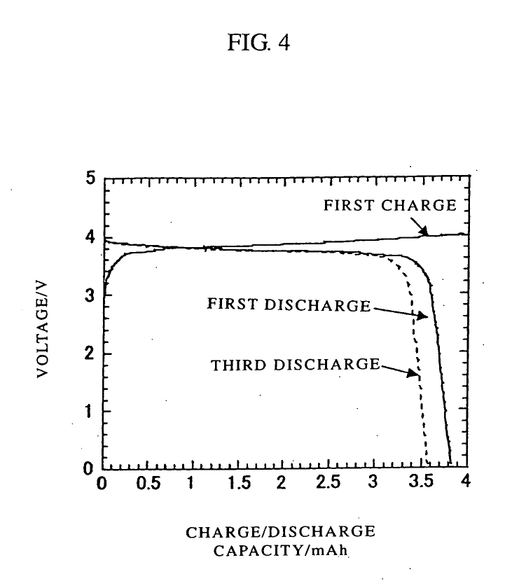

A charge/discharge test is made using the device for testing. The device for testing is charged up to 4 V at the current value of 1 mA and after the device is left at it is for thirty minutes, the device is discharged up to 0 V at the current value of 1 mA. The charge/discharge test is repeated three times. FIG. 4 shows the results.

It is known from the results that the device according to the invention is provided with the satisfactory efficiency of charge/discharge (the ratio of charged quantity and discharged quantity) since initial charge/discharge and operation for discharging up to 0 V is satisfactorily repeated. In first discharge, service capacity at 3 V is 3.60 mAh, while service capacity up to 0 V is 3.81 mAh and service capacity is enhanced by 0.21 mAh equivalent to 5.8% in operation from 4 V to 0 V for operation from 4 V to 3 V. As described above, according to the invention, it can be verified that a high-output electrochemical energy storage device provided with high voltage of 4 V and a range of operating voltage of 4V is acquired.

### Example 2

A battery for testing equivalent to example 2 is produced as in example 1 except that LiMn₂O₄ is used for positive electrode active material and a charge/discharge test is made on the similar condition to that in example 1. Negative electrode active material and a separator are the same as those in example 1.

### Example 3

A battery for testing equivalent to example 3 is produced as in example 1 except that graphite carbon the d value (distance between carbon planes) of which is 0.35 mm is used for negative electrode active material, and a charge/discharge test is made on the similar condition to that in example 1. Positive electrode active material and a separator are the same as those in example 1.

### Example 4

A battery for testing equivalent to example 4 is produced as in example 1 except that a carbon layer is formed on aluminum foil by vapor phase epitaxy is used for a collector base substrate, and a charge/discharge test is made on the similar condition as that in example 1. Positive electrode active material, negative electrode active material and a separator are the same as those in example 1.

### Example 5

A battery for testing equivalent to example 5 is produced as in example 1 except that after aluminum is deposited on a polyethylene terephthalate film for a collector base substrate, a carbon layer is formed by vapor phase epitaxy. Positive electrode active material, negative electrode active material and a separator are the same as those in example 1.

### Example 6

A battery for testing equivalent to example 6 is produced as in example 1 except that LiCoO₂ is used for positive electrode material. Negative electrode active material, a separator and a carbonaceous base substrate are the same as those in example 1. As a result of the charge/discharge tests, these batteries caused no failure such as a short circuit after the charge/discharge of three times.

1. An electrochemical energy storage device, comprising:
a positive electrode provided with a positive electrode collector and positive electrode active material which is held by the positive electrode collector and can occlude/emit a metal ion;
a negative electrode provided with a negative electrode collector and negative electrode active material which is held by the negative electrode collector and which can occlude/emit the metal ion;
a minutely porous separator held between the positive electrode and the negative electrode; and
an organic electrolyte, wherein:
a range of operating voltage is equivalent to a range from below 2 V to 4 V or more.

2. An electrochemical energy storage device according to claim 1, wherein:
the operating voltage ranges from 0 V to 4.2 V.

3. An electrochemical energy storage device according to claim 1, wherein:
the positive electrode collector and the negative electrode collector are made of material including carbonaceous material.

4. An electrochemical energy storage device, comprising:
a positive electrode provided with a positive electrode collector made of carbonaceous material and positive electrode active material which is held by the positive electrode collector and can occlude/emit a metal ion;
a negative electrode provided with a negative electrode collector made of carbonaceous material and negative electrode active material which is held by the negative electrode collector and can occlude/emit a metal ion;
a minutely porous separator held between the positive electrode and the negative electrode; and
an organic electrolyte.

5. An electrochemical energy storage device according to claim 4, wherein:
either of the positive electrode collector or the negative electrode collector or both is/are made of a carbon fiber.

6. An electrochemical energy storage device according to claim 5, wherein:
the carbon fiber is woven cloth.

7. An electrochemical energy storage device according to claim 6, wherein:
the positive electrode active material or the negative electrode active material is applied to the carbon fiber.

8. An electrochemical energy storage device according to claim 4, wherein:
either or both of the positive electrode collector or/and the positive electrode active material and either or both of the negative electrode collector or/and the negative electrode active material are held on metallic foil.

9. An electrochemical energy storage device according to claim 4, wherein:
either or both of the positive electrode collector or/and the positive electrode active material and either or both of the negative electrode collector or/and the negative electrode active material are held on a plastic sheet.

10. An electrochemical energy storage device according to claim 4, wherein:
either or both of the positive electrode collector or/and the positive electrode active material and either or both of the negative electrode collector or/and the negative electrode active material are held on a metallized plastic sheet.

11. An electrochemical energy storage device according to claim 4, wherein:
a lithium salt is dissolved in the organic electrolyte.
